(19) United States
(12) Patent Application Publication
(10) Pub. No.: US 2001/0025312 A1
(43) Pub. Date: Sep. 27, 2001

(54) Information processing system

(76) Inventor: Toshinori Obata, Hadano (JP)

Correspondence Address: Mattingly, Stanger & Malur, P.C., 104 East Hume Avenue, Alexandria, VA, 22301, US

(21) Appl. No.: 09/767,708

(22) Filed: Jan. 24, 2001

(30) Foreign Application Priority Data
Jan. 27, 2000 (JP) 2000-018480

(51) Int. Cl. G06F 15/173

(52) U.S. Cl. 709/226; 709/224

(57) ABSTRACT

A system for enabling a system down due to a lack of ability to be avoided and enabling a dynamic backup to be performed by properly allocating resources to a processing ability is provided. Each of a plurality of host systems connected through an information network is provided with a system status monitering and change instructing mechanism which is physically independent of other component elements of the relevant host system, has a status management table of resources such as IPs, memory segments, and the like, and can enhance and reduce an ability of the host.

### BACKGROUND OF THE INVENTION

The invention relates to an information processing technique and, more particularly, to a technique which is effective when it is applied to a dynamic ability change, a hot standby switching, or the like of a host system.

Hitherto, even if an ability enhancement of a host can be executed during the operation of a system and there is a spare resource in the host, in order to enhance the ability of the host, the operator has manually activated a spare instruction processor (inactive IP). Therefore, when transactions over a processing ability are inputted to the host due to an unexpected situation, the host cannot cope with it in a real-time manner and it is difficult to avoid a system down due to a lack of processing ability.

Further, upon hot standby switching, as shown in “hot standby system” disclosed in JP-A-6-89197, there is also a technique such that an application and a subsystem which are equivalent to those on the side of a current system have previously been activated on the side of a standby system, when the current system is down, it is backed up by the standby system, thereby effectively utilizing the standby system. However, it is necessary to provide a surplus on the assumption that a switching operation for an ability of the standby system is performed. A perfect allocation control up to a resource level such as IP, memory segment, or the like is not performed, and the effective use of the standby system is not always sufficient.

In a host having a spare resource, if transactions of the number over a processing ability are suddenly inputted, the operator copes with such a case by manually executing an activation of the spare resource in a console for maintenance during the operation of the system. There is, however, a problem such that it is impossible to cope with such a case in a real-time manner and it is difficult to avoid a system down.

### SUMMARY OF THE INVENTION

It is an object of the invention to provide an information processing technique which can avoid a system down due to a lack of ability by automatically enhancing the ability without stopping a business at the time of an over-processing ability of a host system.

Another object of the invention is to provide an information processing technique in which in an information processing system comprising a plurality of host systems, upon hot standby switching among a plurality of host systems, an ability of an alternating host system is automatically enhanced and the host system is switched, and the operation by the necessary minimum ability can be always performed. Thus, it is possible to realize a proper investment to a processing ability and avoid a system down due to a lack of ability.

According to the invention, by applying an expanding function during operation of the host to the ability enhancement of the host and the hot standby switching, the ability is automatically enhanced without stopping the business at the time of an over-host processing ability, an ability of an alternating system is automatically enhanced and the host system is switched at the time of the hot standby switching, and the operation by the necessary minimum ability can be always performed. Thus, it is possible to realize a proper investment to a processing ability and avoid a system down due to a lack of ability.

Further, operating situations of the hosts, particularly, an IP and segments are monitored by a remote client and, if necessary, an ability enhancement and an ability reduction are also instructed from the client, thereby making it possible to operate the host system in accordance with an operation schedule.

More specifically speaking, for example, a system status monitering and change instructing mechanism which is physically independent of other component elements and has an operating status management table of resources such as instruction processors (IP), memory segments, and the like and can control an enhancement and a reduction of an ability of the host system is prepared for each of host systems constructing the information processing system, thereby enabling the system status monitering and change instructing mechanism to automatically fluctuate a processing ability of the host system in accordance with a load of the host system.

By mutually connecting the system status monitering and change instructing mechanism provided for each host system and enabling them to communicate with each other, even if the resources of the self host system are lacking, it is possible to cope with such a case by allowing resources to be allocated from another host system.

### BRIEF DESCRIPTION OF THE DRAWINGS

FIG. 1 is a block diagram showing an example of an information processing system according to an embodiment of the invention;

FIG. 2 is a conceptual diagram showing an example of management information which is used in host systems constructing the information processing system according to the embodiment of the invention;

FIG. 3 is a flowchart showing an example of the operation of hot standby switching in the information processing system according to the embodiment of the invention;

FIG. 4 is a flowchart showing an example of a direct instructing process of a resource allocation to a host by a remote console in the information processing system according to the embodiment of the invention together with FIG. 5;

FIG. 5 is a flowchart showing an example of the direct instructing process of the resource allocation to the host by the remote console in the information processing system according to the embodiment of the invention together with FIG. 4;

FIG. 6 is a flowchart showing an example of a mechanism for automatically enhancing a resource such as an IP or the like in the information processing system according to the embodiment of the invention;

FIG. 7 is a flowchart showing an example of a mechanism for automatically deleting the resource such as an IP or the like in the information processing system according to the embodiment of the invention;

FIG. 8 is a flowchart showing an example of a mechanism for automatically enhancing resources such as memory segments or the like in the information processing system according to the embodiment of the invention; and

FIG. 9 is a flowchart showing an example of a mechanism for automatically deleting the resources such as memory segments or the like in the information processing system according to the embodiment of the invention.

### DETAILED DESCRIPTION OF THE EMBODIMENTS

Embodiments of the invention will now be described in detail hereinbelow with reference to the drawings.

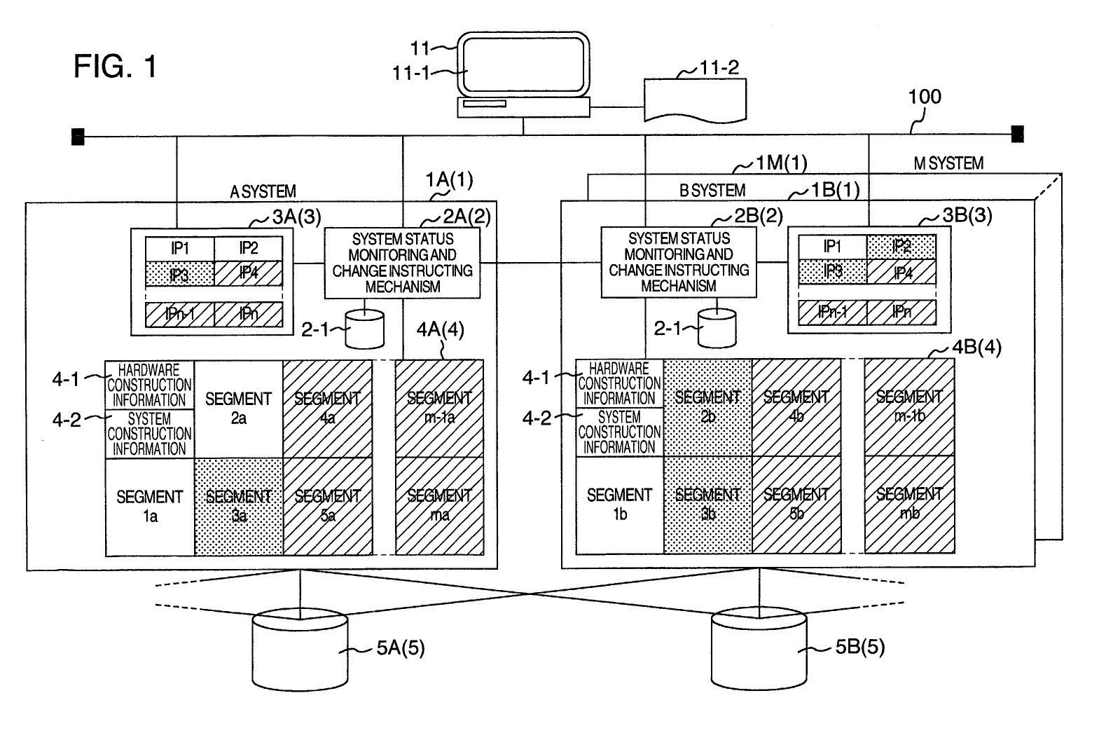

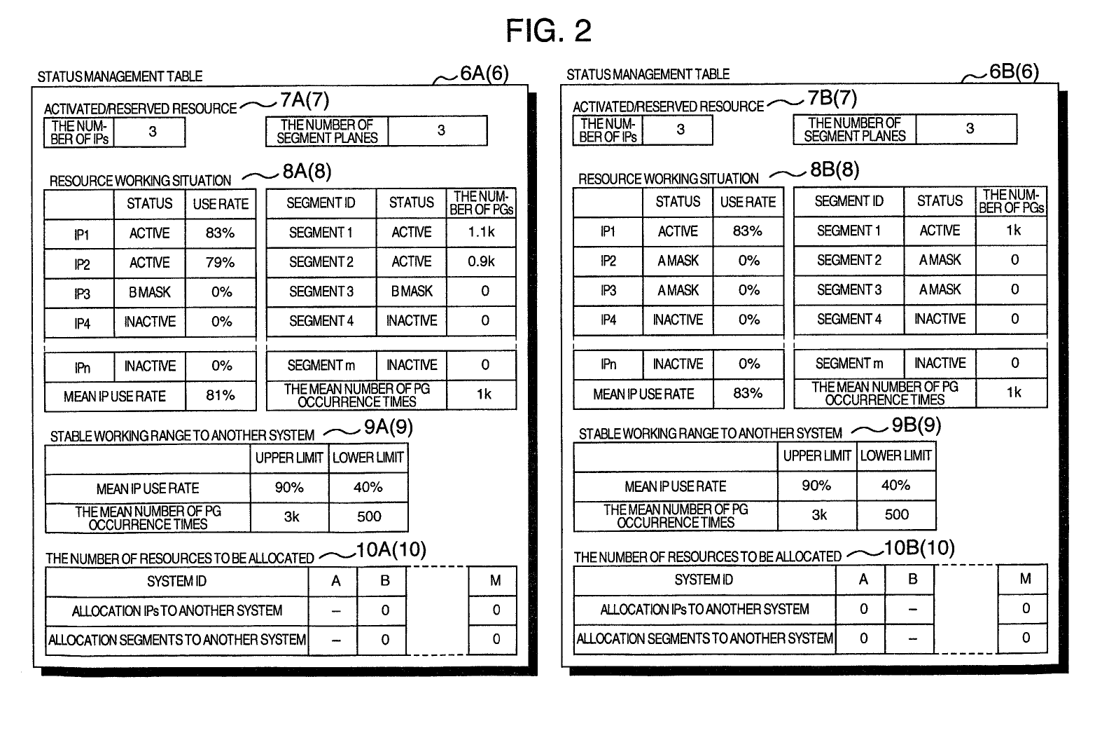

FIG. 1 is a block diagram showing an example of a construction of an information processing system according to an embodiment of the invention. FIG. 2 is a conceptual diagram showing an example of management information which is used in host systems constructing the information processing system according to the embodiment.

The information processing system according to the embodiment is constructed by mutually connecting a plurality of host systems 1 (A system 1A, B system 1B, . . . , M system 1M) through an information network 100. External storage devices 5 (5A, 5B, . . . ) comprising DASDs (Direct Access Storage Devices) such as magnetic disk devices or the like are connected to the plural host systems 1 so as to be mutually shared.

A remote console 11 having a monitor 11-1, a printer 11-2, and a user interface such as a keyboard or the like (not shown) is connected to the information network 100. Maintenance, an operation management, and the like of the plural host systems 1 are performed by the remote console 11.

Resources (components) such as a plurality of instruction processors 3 (3A, 3B, . . . ) (IP1 to IPn), a plurality of memory segments 4 (4A, 4B, . . . ) (1a to ma, 1b to mb), and the like are provided for the respective host systems 1 (1A, 1B, . . . ). Information such as hardware construction information 4-1, system construction information 4-2, and the like of the self host system 1 has been stored in a part of the segment 4.

In the embodiment, for example, the A system 1A and B system 1B are defined as mutual hot standby. Among the resources of the IP3 and segments 4 of the host systems 1, the resources shown as blank portions (in the example of the A system in FIG. 1, IP1, IP2, segments 1a and 2a) (first resources) are used by the self system, and the resources shown as mesh portions (in the example of the A system in FIG. 1, IP3 and segment 3a) (second resources) are reserved as switching destinations (in this case, corresponding to one IP1 and one segment 1b of the B system) of another host system upon hot standby switching. Further, the resources of the mesh portions show components which cannot be used by the OS although a program loading has been completed. The resources shown by hatched portions (in the example of the A system in FIG. 1, IP4 to IPn and segments 4a to ma) (third resources) show a state where the relevant components are in an inactive status and can be allocated to both self and other host systems in accordance with a load fluctuation of the IP and segments.

In case of the embodiment, as shown in FIG. 1, system status monitering and change instructing mechanisms 2 (2A, 2B, . . . ) are provided for each host system 1 and manages statuses of the components in the host system.

Status management tables 6 (6A, 6B, . . . ) having a construction shown as an example in FIG. 2 have been stored in the system status monitering and change instructing mechanisms 2. The status management tables 6 are tables in which various control information necessary for various control operations in the embodiment, which will be explained hereinlater, is stored. The remote console 11 performs a construction change instruction to each system and a status monitor by communication with the system status monitering and change instructing mechanism 2.

An explanation will be made hereinbelow by paying an attention to the A system 1A and B system 1B defined mutually as hot standby destinations.

In the status management table 6 (6A) provided for the A system 1A, an “activated/reserved resource” 7 (7A) indicates the number of IPs and the number of memory segment planes assured in the system. A “resource working situation” 8 (8A) manages a status and use situation of each IP and each segment. In a “stable operating range” 9 (9A), if a mean IP use rate and the mean number of paging occurrence times are deviated out of a range designated by an upper limit and a lower limit, the system status monitering and change instructing mechanism 2A senses them and automatically performs an allocation and a deletion of the resources. When there is not a surplus resource in the resources of the A system 1A, “the number of resources to be allocated to another system” 10 (10A) issues an allocating request to another system and manages the number of obtained IPs and the number of obtained segments.

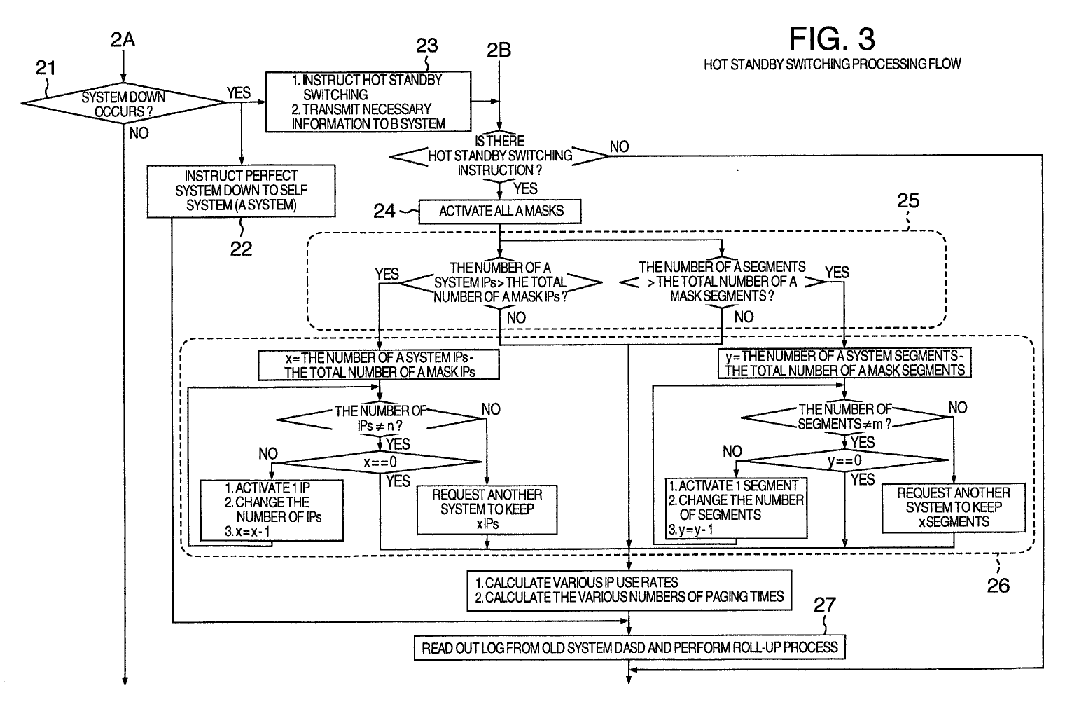

An example of a hot standby switching mechanism in the embodiment will now be described hereinbelow with reference to FIG. 3.

When the A system 1A is down (step 21), the system status monitering and change instructing mechanism 2A of the A system 1A issues a hot standby switching instruction to the B system 1B (step 23) and makes the self A system 1A be perfectly down (step 22).

When the switching instruction is received, the B system 1B activates all of the IPs and memory segments reserved for switching to the A system (step 24). If the ability has been enhanced before the A system 1A is down and if only the number of reserved IPs and the number of reserved segments are used, they are lacking (step 25), the lacking numbers of IPs and segments are supplemented (step 26). After confirming the complete system down of the A system 1A, a log is extracted from the external storage device 5A (DASD) of the old A system 1A, thereby completing the hot standby switching by a roll-up process (step 27).

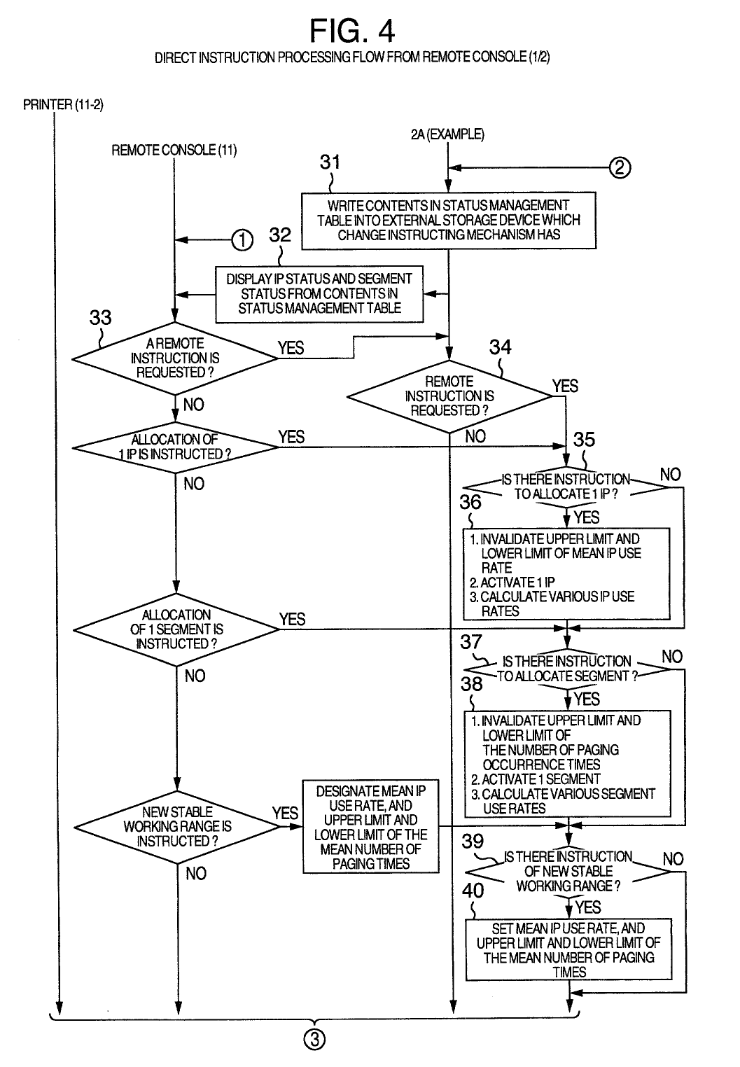

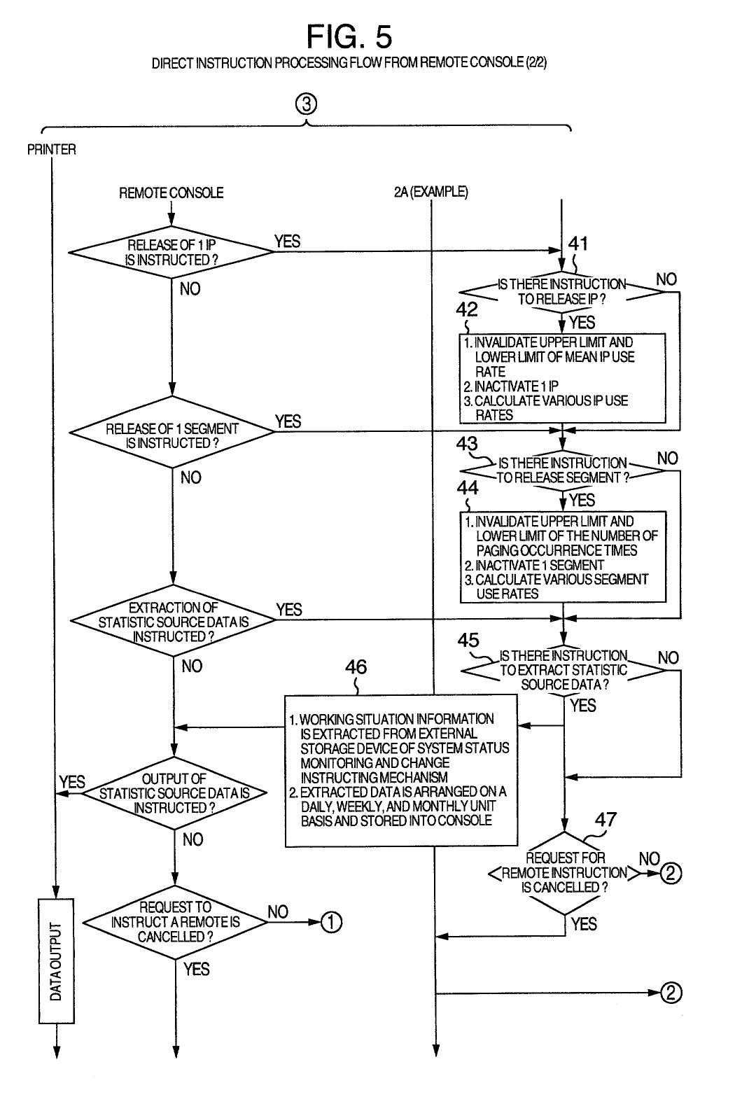

FIGS. 4 and 5 show an example of a direct instruction processing flow to the host by the remote console 11. In FIGS. 4 and 5, (1), (2), and (3) denote connecting relations of the mutual flowcharts. A case where the A system 1A executes processes by a request from the remote console 11 will now be described hereinbelow.

The A system 1A almost periodically outputs the contents in the status management table 6A to an external storage device 2-1 of the system status monitering and change instructing mechanism 2A irrespective of the presence or absence of a request from the remote console 11 (step 31) and allows the monitor 11-1 of the remote console 11 to display an operating situation (step 32). When an instructing request is issued from the remote console 11 to the A system 1A (step 33), the A system 1A enters a remote console instruction processing flow (step 34). If the remote console 11 instructs the IP allocation (step 35), threshold values at the time of the automatic IP enhancement/reduction of the A system 1A are invalidated and one IP is activated (step 36). When the remote console 11 instructs a segment allocation (step 37), threshold values at the time of the automatic segment enhancement/reduction of the A system 1A are invalidated and one segment is activated (step 38).

When the remote console 11 instructs a stable operating range (threshold values at the time of the enhancement/reduction) (step 39), the designated contents are set to the threshold values of the stable operating range (step 40). When the remote console 11 instructs a release of one IP (step 41), the threshold values at the time of the automatic IP enhancement/reduction of the A system 1A are invalidated and one IP is inactivated (step 42). When the remote console 11 instructs a release of one segment (step 43), the threshold values at the time of the automatic segment enhancement/reduction of the A system 1A are invalidated and one segment is inactivated (step 44). When the remote console 11 instructs an extraction of statistic source data (step 45), the working situation information in the external storage device 2-1 of the system status monitering and change instructing mechanism 2A is edited on a daily, weekly, and monthly unit basis and stored in the remote console 11 (step 46). When the instructing request from the remote console 11 is cancelled (step 47), the A system 1A is returned to the ordinary flow.

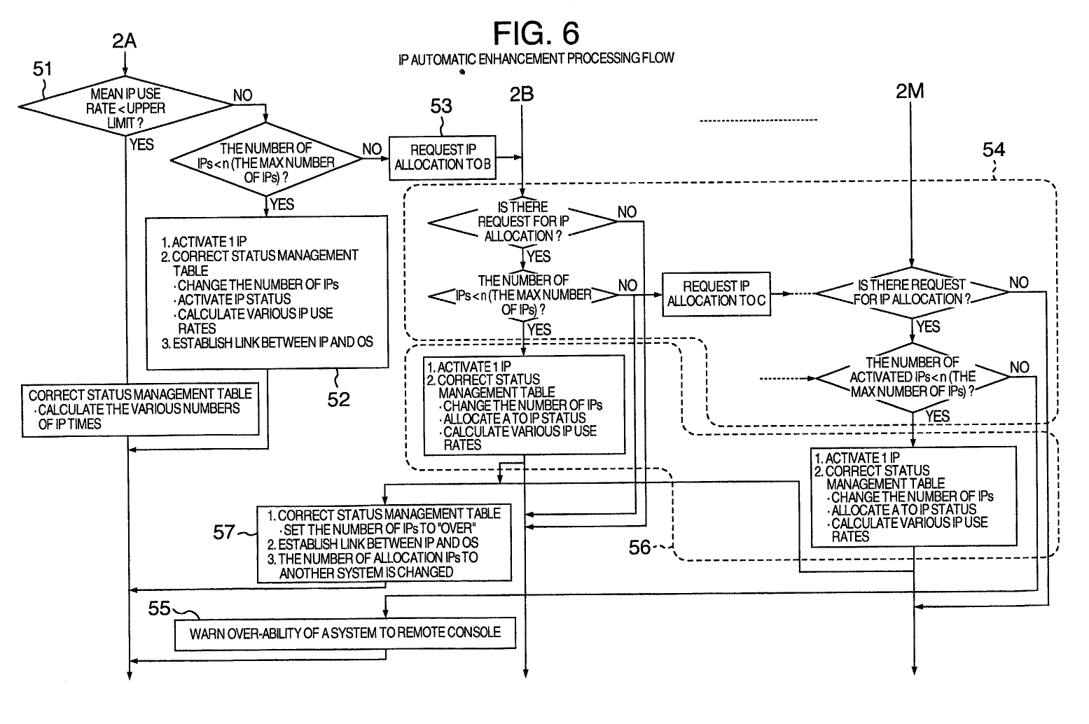

An IP automatic enhancement processing flow shown as an example in FIG. 6 is executed in accordance with the load which is applied to the host.

When the mean IP use rate of the A system 1A exceeds the stable operating range 9A (step 51), if an inactive IP exists in the self system, it is activated (step 52). If it does not exist, the B system 1B is requested to allocate the IP (step 53). If an inactive IP exists in the B system 1B, it is activated. If it does not exist in the B system 1B, an allocating request is issued to the C system 1C and subsequent systems until the existence of the inactive IP is confirmed (step 54). If the inactive IP does not exist even in the last M system, an over-ability of the A system 1A is warned to the remote console 11 (step 55). If the inactive IP exists in one of the systems, it is activated (step 56), thereby establishing a link between the A system 1A and the OS (step 57).

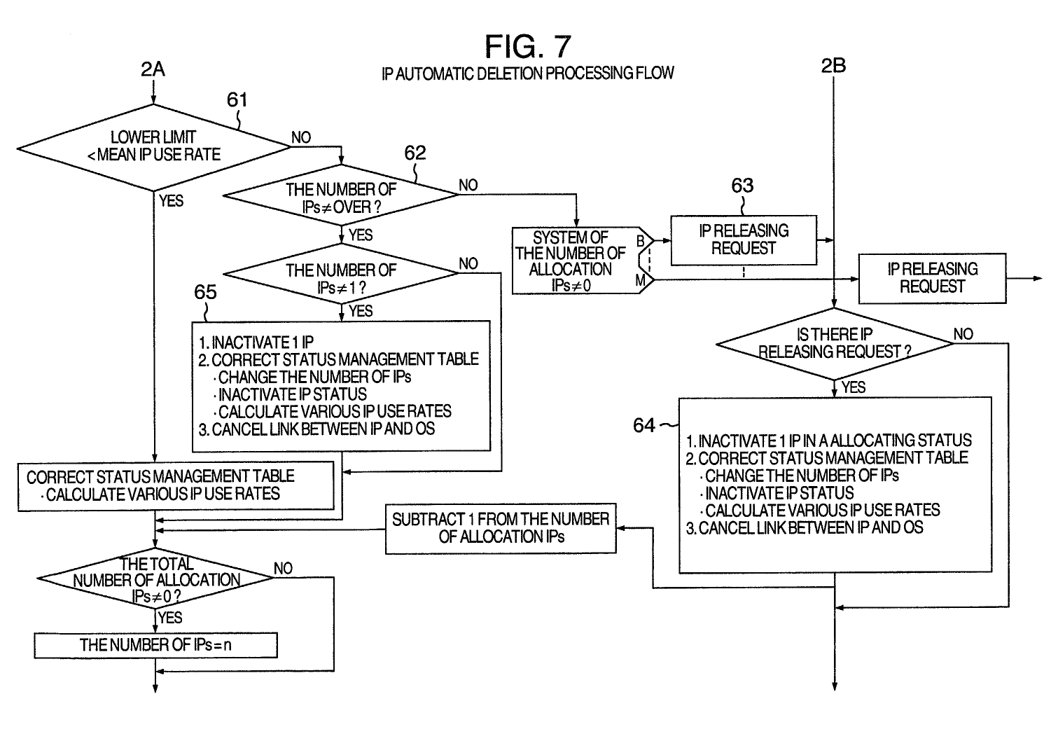

An IP automatic deletion processing flow shown as an example in FIG. 7 is executed in accordance with a decrease in load that is applied to the host.

When the mean IP use rate of the A system 1A is lower than the stable operating range 9A (step 61), if an allocation IP exists in another system (step 62), an IP releasing request is issued to the relevant system (step 63) and the relevant IP is inactivated (step 64). If the allocation IP does not exist and two or more IPs exist in the self system, the self system IP is inactivated (step 65).

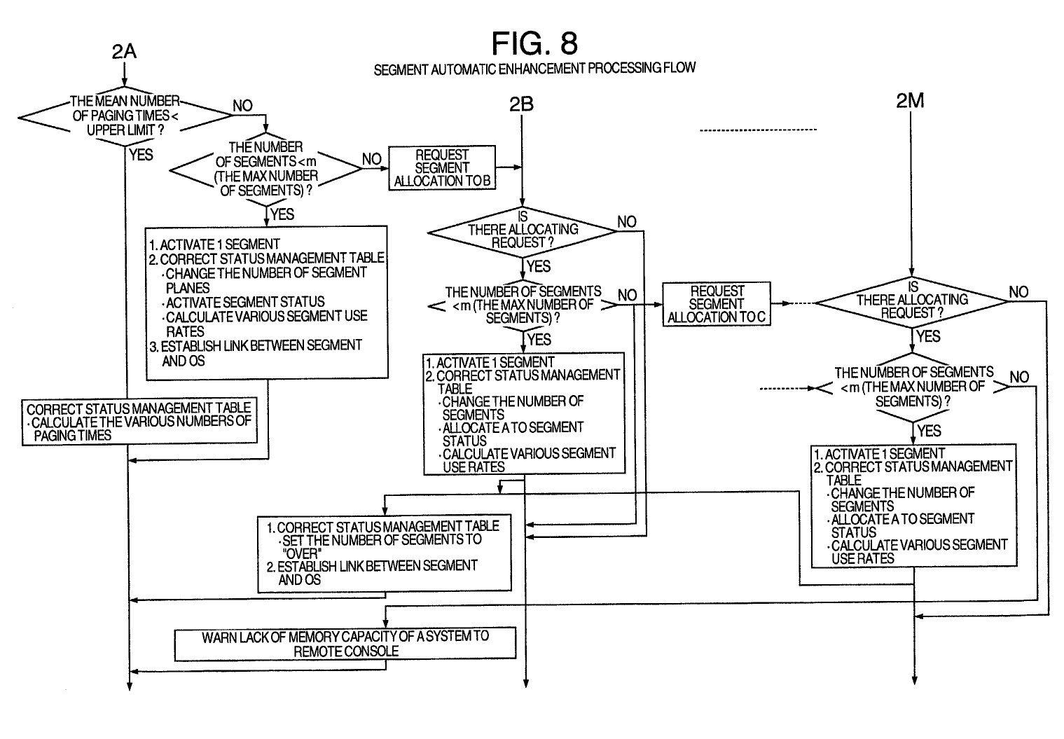

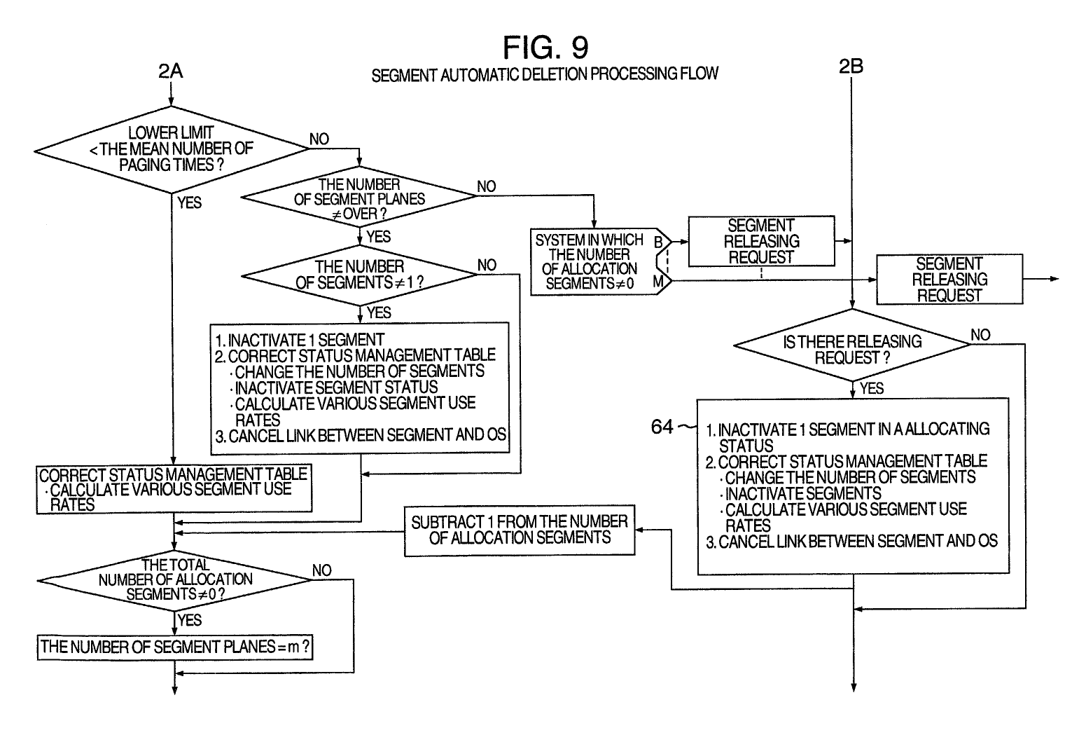

Since the automatic enhancement and automatic deletion regarding the segments can be accomplished by replacing the mean IP use rate with the mean number of paging times and by replacing the IPs with the segments in FIGS. 6 and 7, respectively, their overlapped explanations are omitted. Processing flows are shown in FIGS. 8 and 9.

As described above, according to the information processing system of the embodiment, in each host system 1, at the time of an over-processing ability of the self system, the ability is automatically enhanced by the dynamic allocation of the resources in the self system and another system by the system status monitering and change instructing mechanism 2, status management table 6, and the like without stopping the business. Upon hot standby switching, by allocating the necessary minimum reserved resources in place of the preset hot standby destination, the ability of the alternating system is automatically enhanced and switched, thereby always enabling the operation to be performed by the necessary minimum ability. Thus, it is possible to realize the proper investment to the processing ability and avoid the system down due to the insufficient ability.

For example, the A system 1A is set on a site of the customer, the B system 1B is set on a site of a manufacturer which provides the relevant system, during an ordinary operating period of the customer, the operation is executed only by the A system 1A, and during a busy period of the business or at the time of a system down, he resources of the B system 1B in the manufacturer are dynamically allocated and a fee corresponding to only a use amount of the resources of the B system 1B is charged. By this method, on the customer side, a dynamic ability enhancement during the busy period of time or a construction of a backup system can be realized in accordance with a peak load during the busy period without investing to the resources of an amount larger than it is needed.

Although the invention made by the present inventors has been specifically described above on the basis of the preferred embodiments, the invention is not limited to the foregoing embodiments but many variations and modifications are possible without departing from the spirit of the present invention.

According to the information processing system of the invention, at the time of the over-processing ability of the host system, by automatically enhancing the ability without stopping the business, an effect such that the system down due to the lack of ability can be avoided is derived.

According to the information processing system of the invention, in the information processing system comprising a plurality of host systems, upon hot standby switching among the plural host systems, the ability of the alternating host system is automatically enhanced and the host system is switched and the operation can be always performed by the necessary minimum ability. Thus, an effect such that it is possible to realize the proper investment to the processing ability and avoid the system down due to the lack of ability is obtained.

What is claimed is:

1. An information processing system comprising a plurality of host systems each having resources including a plurality of instruction processors and a plurality of memory segments, wherein
each of said host systems has a system status monitering and change instructing mechanism for managing statuses of said resources by a status management table, and
said system status monitering and change instructing mechanism has means for instructing an enhancement or reduction of an ability of a self host system in accordance with said status management table in accordance with a load that is applied to the self host system.

2. A system according to claim 1, wherein said system status monitering and change instructing mechanism has means for instructing the enhancement of the ability using the resources of another host system in accordance with said status management table in accordance with the load that is applied to the self host system.

3. A system according to claim 1, wherein said system status monitering and change instructing mechanisms of said host systems are mutually connected, arbitrary two host systems which establish a mutual hot standby have a first resource for an ordinary operation of the self host system and a second resource for hot standby to another host system, use said first resource at the time of the ordinary operation, and use said second resource upon hot standby switching.

4. A system according to claim 3, wherein said arbitrary two host systems which establish the mutual hot standby have a third resource which can be allocated at the time of said ordinary operation and at the time of said hot standby switching.

5. An information processing system comprising a plurality of host systems which mutually independently operate and include instruction processors and memory segments and in which there is a surplus in the resources, wherein
each of said host systems has a system status monitering and change instructing mechanism which is physically independent of other component elements in said relevant host system and has an operating status management table of said resources, and each of said host systems has a function for automatically enhancing or reducing an ability of a self host system in accordance with said status management table in accordance with a load that is applied to the self host system.

6. A system according to claim 5, wherein said system has a function for enhancing or reducing the ability by using the resources of another host system in accordance with said status management table in accordance with the load that is applied to the self host system.

7. A system according to claim 5, wherein said system status monitering and change instructing mechanisms of said host systems are mutually connected, arbitrary two host systems which establish a mutual hot standby have a first resource for an ordinary operation of the self host system and a second resource for hot standby to another host system, use said first resource at the time of the ordinary operation, and use said second resource upon hot standby switching.

8. A system according to claim 7, wherein said arbitrary two host systems which establish the mutual hot standby have a third resource which can be allocated at the time of said ordinary operation and at the time of said hot standby switching.

9. A system according to claim 5, wherein each of said host systems is connected to a remote console for integratedly managing all of the host systems, and each of the host systems has a function for setting a threshold value for said automatic enhancement or reduction in response to an instruction from said remote console.

10. A control method for an information processing system having a plurality of instruction processors and a plurality of memory segments, comprising the steps of:
setting an upper limit value and a lower limit value of a mean use rate of said plurality of instruction processors as a stable operating range;
activating the inactive instruction processors when said mean use rate of said instruction processors exceeds said upper limit value during the operation; and
inactivating the active instruction processor when said mean use rate of said instruction processors is lower than said lower limit value during the operation.

11. A method according to claim 10, further comprising the steps of:
setting an upper limit value and a lower limit value of the mean number of paging occurrence times of said plurality of memory segments as a stable operating range;
activating the inactive memory segments when said mean number of paging occurrence times of said memory segments exceeds said upper limit value during the operation; and
inactivating the active memory segment when said mean number of paging occurrence times of said memory segments is lower than said lower limit value during the operation.
